(19) United States
(12) Patent Application Publication
(10) Pub. No.: US 2017/0320227 A1
(43) Pub. Date: Nov. 9, 2017

(54) Machining Tool

(71) Applicant: ROBERT BOSCH GMBH, Stuttgart (DE)

(72) Inventors: Uwe Engelfried, Ostfildern (DE); Rudolf Fuchs, Neuhausen (DE); Thomas Duerr, Asperg (DE)

(21) Appl. No.: 14/901,076

(22) PCT Filed: May 8, 2014
(86) PCT No.: PCT/EP2014/059450

§ 371 Date: Dec. 28, 2015

(30) Foreign Application Priority Data
Jun. 28, 2013 (DE) 10 2013 212 604.2

(51) Int. Cl. B27B 17/00

(52) U.S. Cl. CPC B27B 17/0083; B27B 17/0041

(57) ABSTRACT

A machining tool, in particular to a rotating cutter machining tool, includes at least one cutting strand and at least one cutting strand-guiding unit. The machining tool also includes at least one cutting edge-guiding unit disposed on the cutting strand-guiding unit. The cutting edge-guiding unit has a maximum transverse extension that is equal to or greater than a maximum cutting width of the cutting strand.

### PRIOR ART

Machining tools which comprise a cutting strand and a cutting strand guide unit are already known.

### DISCLOSURE OF THE INVENTION

The invention is based on a machining tool, in particular a rotating cutter machining tool, having at least one cutting strand and having at least one cutting strand guide unit.

It is proposed that the machining tool comprises at least one cutting edge guide unit arrangeable on the cutting strand guide unit and having a maximum transverse extent which is equal to or greater than a maximum cutting width of the cutting strand. Preferably, the cutting edge guide unit in this case has a maximum transverse extent which corresponds in particular to at least 1.1 times, preferably at least 1.5 times, particularly preferably at least 1.8 times the maximum cutting width of the cutting strand. It is also conceivable, however, for the cutting edge guide unit to have a maximum transverse extent which is less than 1.1 times the maximum cutting width of the cutting strand, or for the cutting edge guide unit to have a maximum transverse extent which is greater than 1.5 times the maximum cutting width of the cutting strand. By a “cutting strand” should here be understood, in particular, a unit which is designed to locally undo an atomic coherence of a workpiece to be machined, in particular by means of a mechanical separation and/or by means of a mechanical removal of material particles of the workpiece. Preferably, the cutting strand is designed to separate the workpiece into at least two physically mutually separate parts, and/or to at least partially separate and/or remove material particles of the workpiece, starting from a surface of the workpiece. The cutting width of the cutting strand extends preferably along a direction running at least substantially perpendicular to a cutting plane of the cutting strand. The cutting strand is particularly preferably configured as an endless cutting strand, in particular as a cutting chain, which can be rotatingly and/or oscillatingly driven along a periphery of the cutting strand guide unit.

Preferably, the cutting strand, viewed along a direction running at least substantially perpendicular to the cutting plane of the cutting strand, has a maximum dimension less than 4 mm. Preferably, the dimension is configured as the width, in particular as the cutting width, of the cutting strand. Particularly preferably, the cutting strand, viewed along the direction running at least substantially perpendicular to the cutting plane of the cutting strand, has an at least substantially constant maximum dimension. The maximum dimension corresponds along the total length of the cutting strand preferably to a value from within a range of values from 1 mm to 3 mm. Thus the cutting strand is preferably designed to create a cutting gap which, viewed along the direction running at least substantially perpendicular to the cutting plane of the cutting strand, has a maximum dimension less than 4 mm. Particularly advantageously, cutting gaps of small dimensions can be created, by the cutting strand, viewed along the direction running at least substantially perpendicular to the cutting plane of the cutting strand, having a maximum dimension ranging between 1.3 mm and 2.2 mm. Thus the cutting strand is preferably designed to create a cutting gap which, viewed along the direction running at least substantially perpendicular to the cutting plane of the cutting strand, has a maximum dimension ranging between 1.3 mm and 2.2 mm. It is also conceivable, however, for the cutting strand, viewed along the direction running at least substantially perpendicular to the cutting plane of the cutting strand, to have a maximum dimension which is less than 1.3 mm.

By a “cutting strand guide unit” should here be understood, in particular, a unit which is designed to exert a constraining force on the cutting strand, at least along a direction perpendicular to a cutting direction of the cutting strand, in order to define a mobility of the cutting strand along the cutting direction. Preferably, the cutting strand guide unit has at least one guide element, in particular a guide groove, by which the cutting strand is guided. Preferably, the cutting strand, viewed in the cutting plane, along an at least substantially total periphery of the cutting strand guide unit, is guided through the cutting strand guide unit by means of the guide element, in particular the guide groove. Particularly preferably, the cutting strand and the cutting strand guide unit form a closed system. The term “closed system” is here intended to define, in particular, a system comprising at least two components, which, by means of an interaction, in a disassembled state of the system from a system (such as, for instance, of the portable power tool) that is superordinate to the system, maintain functionality, and/or which, in a state disassembled from the portable power tool, are captively connected to each other. Preferably, the cutting strand and the cutting strand guide unit are mutually connected in such a way that they are at least substantially non-releasable for a user. By “at least substantially non-releasable” should here be understood, in particular, a connection of at least two components which can be separated from each other only with the aid of parting tools, such as, for instance, a saw, etc., and/or chemical parting agents, such as, for instance, solvents etc.

The term “cutting plane” is here intended to define, in particular, a plane in which the cutting strand, in at least one operating state, is moved along a periphery of the cutting strand guide unit in at least two mutually oppositely directed cutting directions relative to the cutting strand guide unit. Preferably, the cutting plane, in a machining of a workpiece, is oriented at least substantially transversely to a workpiece surface to be machined. By “at least substantially transversely to” should here be understood, in particular, an orientation of a plane and/or of a direction relative to a further plane and/or a further direction, which orientation preferably differs from a parallel orientation of the plane and/or of the direction relative to the further plane and/or the further direction. It is also conceivable, however, for the cutting plane, in a machining of a workpiece, to be oriented at least substantially parallel to a workpiece surface to be machined, in particular where the cutting strand is configured as an abrasive, etc. By “at least substantially parallel” should here be understood, in particular, an orientation of a direction relative to a reference direction, wherein the direction and the reference direction, in particular viewed in a plane, form an angle of 90° and the angle has a maximum deviation of, in particular, less than 8°, advantageously less than 50, and particularly advantageously less than 2°. By a “cutting direction” should here be understood, in particular, a direction along which the cutting strand, for the creation of a cutting gap and/or for the separation and/or for the abrasion of workpiece particles of a workpiece to be machined, is moved in at least one operating state, as a result of a drive force and/or a drive torque, in particular in the guide groove of the cutting strand guide unit. Preferably, the cutting strand, in an operating state, is moved along the cutting direction relative to the cutting strand guide unit in the guide groove.

Particularly preferably, the machining tool has a total mass which is less than 500 g. Preferably, the machine tool parting device has a total mass which is less than 100 g, and particularly preferably less than 50 g. Moreover, the machining tool preferably has a maximum longitudinal extent which is less than 300 mm.

Preferably, the machining tool has a maximum longitudinal extent which is greater than 30 mm Advantageously, the cutting strand guide unit together with the mounted cutting strand, viewed along a direction running at least substantially parallel to the cutting plane of the cutting strand and at least substantially perpendicular to a direction of principal extent of the cutting strand guide unit, has a maximum dimension less than 50 mm. Preferably, the cutting strand guide unit together with the mounted cutting strand, viewed along the direction running at least substantially parallel to the cutting plane of the cutting strand and at least substantially perpendicular to the direction of principal extent of the cutting strand guide unit, has a dimension less than 30 mm, particularly preferably less than 25 mm. The dimension is preferably configured as the total height of the cutting strand guide unit together with the cutting strand mounted on the cutting strand guide unit. Thus the cutting strand is preferably designed to create, in particular as a result of a one-off intrusion of the machining tool into the workpiece, a cutting gap which, viewed along a direction running at least substantially parallel to the cutting plane of the cutting strand and at least substantially perpendicular to the direction of principal extent of the cutting strand, has a maximum dimension less than 50 mm. Preferably, the cutting strand is designed to create, in particular as a result of a one-off intrusion of the machining tool into the workpiece, a cutting gap which, viewed along the direction running at least substantially parallel to the cutting plane of the cutting strand and at least substantially perpendicular to the direction of principal extent of the cutting strand guide unit together with the mounted cutting strand, a dimension ranging between 10 mm and 30 mm, and particularly preferably a dimension ranging between 11 mm and 25 mm. By a “direction of principal extent” should here be understood, in particular, a direction along which the cutting strand guide unit together with the mounted cutting strand has a maximum extent.

By a “cutting strand guide unit” should here be understood, in particular, a unit which is designed to guide the machining tool, in particular by means of an interaction with a guide element of a cutting edge guiding device, along a cutting edge of a cut to be made by means of the machining tool into a workpiece to be machined, and to prevent drifting of the machining tool and/or deviation of the machining tool from a desired cutting line. The expression “designed” is intended to define specifically arranged and/or specifically equipped. By an object being designed for a particular function should be understood, in particular, that the object fulfils and/or performs this particular function in at least one application state and/or operating state. By means of the inventive design of the machining tool, a constructively simple and precise guidance during machining of a workpiece can advantageously be enabled. Precise work results can thus advantageously be enabled. Moreover, a particularly compact machining tool, which can be precisely guided by means of the machining tool guiding device, can advantageously be achieved.

Furthermore, it is proposed that the cutting edge guide unit has at least one fastening element for a positive and/or non-positive fastening to the cutting strand guide unit. The fastening element can in this case be configured as a threaded bolt, as a rivet, as a latching hook, etc. The fastening element is preferably arranged on a side wall element of the cutting strand guide unit. Thus the cutting edge guide unit is fastened preferably to the side wall element. In this case, the cutting strand guide unit is preferably of multipart configuration. It is also conceivable, however, for the cutting strand guide unit to have just a single component, to which the cutting edge guide unit is fastened by means of the fastening element. In an alternative embodiment, the cutting edge guide unit is configured at least partially in one piece with the cutting strand guide unit. By “in one piece” should be understood, in particular, at least integrally connected, for instance by a welding process, a bonding process, an injection process and/or another process which appears sensible to the person skilled in the art, and/or advantageously formed in one piece, such as, for instance, by production from one casting and/or by a production in a single-component or multi-component injection process, and advantageously from a single blank. By means of the inventive design, a simple fastening of the cutting edge guide unit to the cutting strand guide unit can advantageously be enabled. Thus the cutting edge guide unit can advantageously be removably arranged on the cutting strand guide unit. An arrangement of the cutting edge guide unit can thus advantageously be enabled in dependence on a field of application of the machining tool.

It is further proposed that the cutting edge guide unit has at least one cutting edge guide element, which is movably mounted on the cutting strand guide unit. The expression “movably mounted” is here intended to define, in particular, a mounting of a unit and/or of an element wherein the unit and/or the element, in particular decoupled from an elastic deformation of the unit and/or of the element, has a mobility along at least one path greater than 1 mm, preferably greater than 2 mm, and particularly preferably greater than 5 mm, and/or a mobility about at least one axis through an angle greater than 5°, preferably greater than 8°, and particularly preferably greater than 10°. The cutting edge guide element is preferably mounted on the cutting strand guide unit such that it is translatorily movable along a longitudinal axis of the cutting strand guide unit. It is also conceivable, however, for the cutting edge guide element to alternatively or additionally be mounted in a rotationally movable manner on the cutting strand guide unit. By means of the inventive design of the machining tool, an adaptation of the cutting edge guide unit to different workpiece thicknesses can advantageously be enabled.

In addition, it is proposed that the cutting edge guide unit has at least one stop element, which, viewed along at least one direction running at least substantially parallel to the cutting plane of the cutting strand, extends beyond the cutting strand. The stop element can in this case be arranged fixedly or movably on the cutting strand guide unit. The stop element is preferably designed to limit a motional path of the machining tool relative to a workpiece. Thus undesirable cutting gaps, or damage to the machining tool or to a support on which a workpiece to be machined is disposed, can at least be very largely prevented or be kept small.

Furthermore, it is proposed that the stop element is configured at least partially in one piece with a cutting edge guide element of the cutting edge guide unit. Preferably, the stop element is in this case disposed on a side wall element of the cutting strand guide unit. It is also conceivable, however, for the stop element to be disposed on another element of the cutting edge guide unit which appears sensible to a person skilled in the art. By means of the inventive design, a compact cutting edge guide unit can advantageously be realized. Moreover, the cutting edge guide unit can thus advantageously fulfill different functions.

It is further proposed that the stop element is of resilient configuration. By “resilient” should be understood, in particular, a property, in particular a material-related and/or a shape-related property of an element, which property enables repeated deformation without the element being thereby damaged or destroyed, wherein the element, as a result of this property, in particular following a deformation, independently strives to revert to a basic shape. Thus an automatic adaptation of a position of the stop element to, for instance, a workpiece thickness can advantageously take place. Moreover, a clamping of the workpiece by means of the stop element can advantageously be achieved.

Moreover, a portable power tool system having at least one portable power tool, having at least one machining tool according to the invention, and having at least one cutting edge guiding device, which latter comprises at least one guide element designed to interact with the cutting edge guide unit of the machining tool, is proposed. By a “portable power tool” should here be understood, in particular, a machine tool, in particular a portable power tool, which can be transported without a transport machine by a user. The portable power tool has, in particular, a mass which is less than 40 kg, preferably less than 10 kg, and particularly preferably less than 5 kg. By means of the inventive design of the portable power tool system, a precise machining of a workpiece can advantageously be enabled.

Furthermore, it is proposed that the guide element is configured as a guide rail, which has a guide geometry that varies along at least one direction. By a “varying guide geometry” should here be understood, in particular, a variation of a geometry of the guide element, in particular of a guide groove of the guide element, in at least one section, wherein the variation is configured, for instance, in the form of a taper, a step, etc. In this case, it is conceivable, moreover, that in the section of the guide geometry variation a wear element of the cutting edge guiding device is disposed on the guide element, which wear element is designed to be eroded by the cutting strand during machining of a workpiece. By means of the inventive design, a direct bearing of the machining tool, at least in the section of the guide geometry variation, against the guide element can advantageously be ensured. As a result, in a cut-in operation, in particular given a workpiece crack, a precise guidance can in particular advantageously be enabled by means of the cutting strand.

It is further proposed that the guide element comprises at least one maximum guide geometry extent which, viewed along a direction running at least substantially parallel to a cutting plane of the cutting strand, is equal to or greater than a maximum longitudinal extent of a cutting edge guide element of the cutting edge guide unit. Preferably, the guide element, in particular a guide groove of the guide element, in this case has a maximum guide geometry extent which corresponds in particular to at least 1.5 times, preferably at least 2 times, and particularly preferably at least 2.5 times the maximum longitudinal extent of the cutting edge guide element. The maximum guide geometry extent of the guide element runs, particularly preferably, along an at least substantially perpendicular to a workpiece bearing surface of the guide element. In this case, the workpiece bearing surface can be designed to be placed onto a workpiece during guidance or to receive a workpiece during guidance in order to support machining forces acting on the workpiece. By means of the inventive design of the portable power tool system, the cutting edge guide element can advantageously be connected to the guide element in a user-friendly, in particular clamp-free manner and, in particular, can advantageously be guided with low play.

In addition, it is proposed that the guide element comprises at least one guide groove, into which the machining tool during machining of a workpiece extends at least partially. In this case, the machining tool preferably extends into the guide groove at least with a section of the cutting strand guide unit on which the cutting edge guide unit is disposed. As a result, a particularly comfortable guidance can be enabled.

The machining tool according to the invention and/or the portable power tool system according to the invention should in this case not be confined to the above-described application(s) and embodiment(s). In particular, the machining tool according to the invention and/or the portable power tool system according to the invention can have, for fulfillment of a herein described working method, a number which deviates from a herein stated number of individual elements, components and units.

### DRAWING

Further advantages emerge from the following drawing description. In the drawing, illustrative embodiments of the invention are represented. The drawing, the description and the claims contain numerous features in combination. The person skilled in the art will expediently view the features also individually and put them together them into sensible further combinations.

FIG. 1 shows a portable power tool system according to the invention, having a machining tool according to the invention in a state arranged on a portable power tool of the portable power tool system according to the invention, and having a cutting edge guiding device according to the invention, in a schematic representation,

FIG. 2 shows a detailed view of the machining tool according to the invention, in a schematic representation,

FIG. 3 shows a detailed view of the machining tool according to the invention in a state connected to the cutting edge guiding device, in a schematic representation,

FIG. 4 shows a sectional view of an alternative embodiment of a guide element of the portable power tool system according to the invention, in a schematic representation,

FIG. 5 shows a detailed view of an alternative portable power tool system according to the invention, in a schematic representation,

FIG. 6 shows a detailed view of a further alternative portable power tool system according to the invention, in a schematic representation,

FIG. 7 shows a detailed view of an alternative machining tool according to the invention of further alternative portable power tool system according to the invention, in a schematic representation,

FIG. 8 shows a detailed view of the alternative machining tool according to the invention in a state connected to a cutting edge guiding device of the further alternative portable power tool system according to the invention, in a schematic representation, and

FIG. 9 shows a sectional view of the alternative machining tool according to the invention, in a schematic representation.

### DESCRIPTION OF THE ILLUSTRATIVE EMBODIMENTS

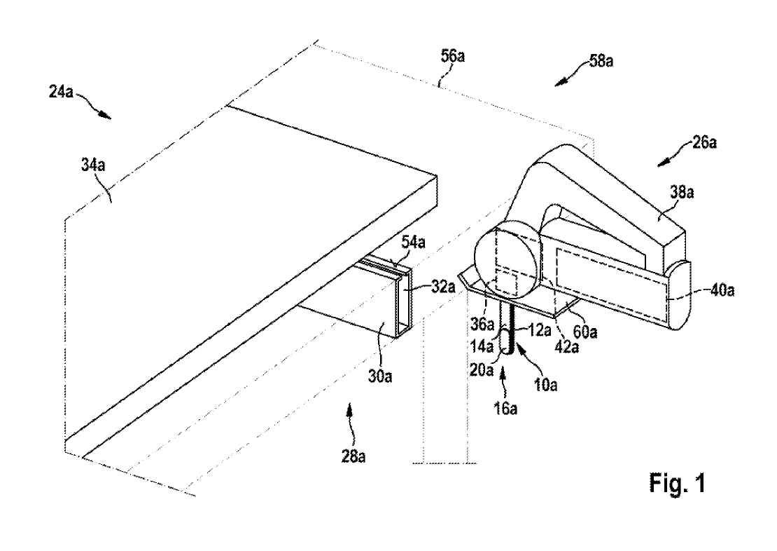

FIG. 1 shows a portable power tool system 24a having at least one portable power tool 26a, having at least one machining tool 10a, and having at least one cutting edge guiding device 28a, which latter comprises at least one guide element 30a designed to interact with a cutting edge guide unit 16a of the machining tool 10a. The portable power tool 26a has a coupling device 36a for a positive and/or non-positive coupling with the machining tool 10a. The coupling device 36a can in this case be configured as a bayonet catch and/or as another coupling device which appears sensible to a person skilled in the art.

Furthermore, the portable power tool 26a comprises at least one bearing unit 60a for supporting the portable power tool 26a on a surface of the workpiece 34a to be machined, wherein the workpiece 34a, for machining by means of the machining tool 10a, is arrangeable between the bearing unit 60a of the portable power tool 26a and a guide element 30a of the cutting edge guiding device 28a. The bearing unit 60a is configured as a sliding block or as a base plate of the portable power tool 26a. The bearing unit 60a can in this case comprise a coated sliding surface, by means of which the portable power tool 26a can slide on the surface of the workpiece 34a during a movement along a motional direction of the machining.

The portable power tool 26a further has a machine tool housing 38a, which encloses a drive unit 40a and a transmission unit 42a of the portable power tool 26a. The drive unit 40a and the transmission unit 42a are functionally connected to each other, in a manner which is already known to a person skilled in the art, for the generation of a drive torque transmissible to the machining tool 10a. The transmission unit 42a is configured as an angular gear. The drive unit 40a is configured as an electric motor unit. It is also conceivable, however, for the drive unit 40a and/or the transmission unit 42a to have another embodiment which appears sensible to a person skilled in the art. The drive unit 40a is designed to drive a cutting strand 12a of the machining tool 10a in at least one operating state at a cutting speed less than 6 m/s. In this case, the portable power tool 26a has at least one operating mode in which a driving of the cutting strand 12a in a cutting strand guide unit 14a of the machining tool 10a along a cutting direction of the cutting strand 12a at a cutting speed less than 6 m/s is enabled.

The cutting strand 12a is guided by means of the cutting strand guide unit 14a. To this end, the cutting strand guide unit 14a has at least one cutting strand guide groove, which extends in a cutting plane of the cutting strand 12a along an at least substantially total periphery of the cutting strand guide unit 14a. In this case, the cutting strand 12a is guided by means of marginal regions of the cutting strand guide unit 14a, which marginal regions delimit the cutting strand guide groove. It is also conceivable, however, for the cutting strand guide unit 14a to have another embodiment which appears sensible to a person skilled in the art, for the guidance of the cutting strand 12a, such as, for instance, a rib-like molding on the cutting strand guide unit 14a, which molding engages in a recess on the cutting strand 12a, etc. The cutting strand 12a, viewed in a plane running perpendicular to the cutting plane, is surrounded from three sides by the marginal regions which delimit the cutting strand guide groove. The cutting strand 12a is moved during operation rotatingly along the periphery in the cutting strand guide groove relative to the cutting strand guide unit 14a.

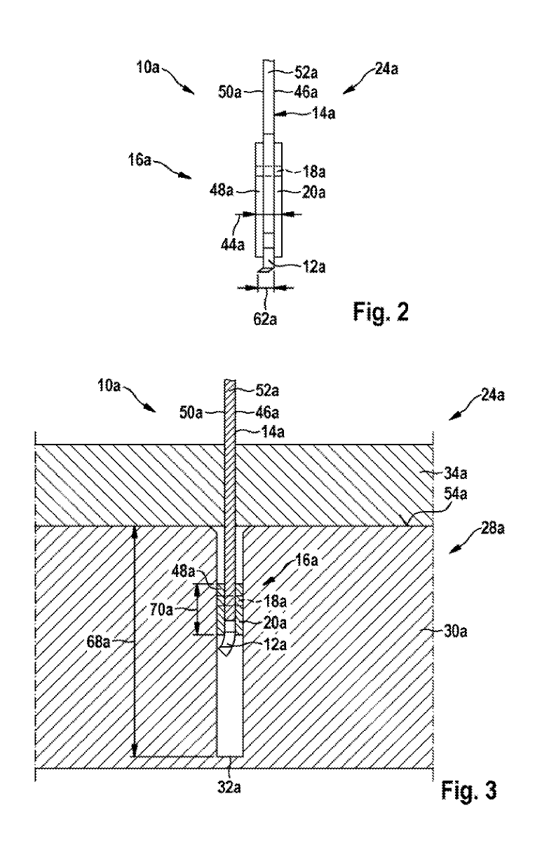

Furthermore, the machining tool 10a comprises at least the cutting edge guide unit 16a arrangeable on the cutting strand guide unit 14a and having a maximum transverse extent 44a which is equal to or greater than a maximum cutting width 62a of the cutting strand 12a (FIG. 2). The maximum cutting width 62a of the cutting strand 12a extends along a direction running substantially perpendicular to the cutting plane of the cutting strand 12a. In this case, the maximum cutting width 62a of the cutting strand 12a corresponds to a maximum spacing of two cutting edges of the cutting strand 12, viewed along a direction running at least substantially perpendicular to the cutting plane of the cutting strand 12a. The maximum transverse extent 44a of the cutting edge guide unit 16a extends likewise along the direction running at least substantially perpendicular to the cutting plane of the cutting strand 12a. In this case, the cutting edge guide unit 16a comprises at least one cutting edge guide element 20a, which is disposed on the cutting strand guide unit 14a. The cutting edge guide element 20a is disposed on a side wall element 46a of the cutting strand guide unit 14a. The cutting edge guide unit 16a further has a further cutting edge guide element 48a. The further cutting edge guide element 48a is disposed on a further side wall element 50a of the cutting strand guide unit 14a. The side wall element 46a and the further side wall element 50a are disposed on sides of the cutting strand guide unit 14a which are facing away from each other. In this case, between the side wall element 46a and the further side wall element 50a is disposed a middle subcomponent 52a of the cutting strand guide unit 14a. The side wall element 46a and the further side wall element 50a are fixed to the middle subcomponent 52a by means of a positive, a non-positive and/or an integrally bonded connection.

Furthermore, the cutting edge guide unit 16a has at least one fastening element 18a for a positive and/or non-positive fastening of the cutting edge guide unit 16a to the cutting strand guide unit 14a (FIG. 2). In this case, the fastening element 18a is provided as a threaded bolt. The fastening element 18a is designed to fasten the cutting edge guide element 20a and/or the further cutting edge guide element 48a to the cutting strand guide unit 14a. The fastening element 18a has in this case a maximum extent which is equal to or less than the maximum transverse extent 44 of the cutting edge guide unit 16a. The fastening element 18a can be screwed into a threaded recess of the middle subcomponent 52a and/or of the side wall element 46a, or the fastening element 18a can extend through a recess through the cutting strand guide unit 14a and be screwed in place by means of a further fastening element (not represented in detail here), such as, for instance, a threaded nut disposed on the cutting edge guide element 20a or on the further cutting edge guide element 48a. It is also conceivable, however, for the cutting edge guide element 20a and/or the further cutting edge guide element 48a to be configured respectively in one piece with the respective side wall element 46a, 50a of the cutting strand guide unit 14a and to respectively form a thickening of the respective side wall element 46a, 50a. In addition, it is conceivable for the cutting edge guide element 20a and the further cutting edge guide element 48a to be configured in one piece.

In an alternative embodiment (not represented here), it is also conceivable for the cutting edge guide element 20a and the further cutting edge guide element 48a to be arranged movably on the cutting strand guide unit 14a. In this case, the fastening element 18a could extend through an elongate recess disposed in the cutting strand guide unit 14a. As a result of a release of the fastening element 18a, a translatorily movable arrangement of the cutting edge guide element 20a and of the further cutting edge guide element 48a could hence be enabled. Other embodiments of the cutting edge guide unit 16a which appear sensible to a person skilled in the art, for a movable mounting of the cutting edge guide element 20a and of the further cutting edge guide element 48a, are likewise conceivable.

For guidance of the machining tool 10a as a cut is made in a workpiece 34a, the portable power tool system 24a has the cutting edge guiding device 28a. The cutting edge guiding device 28a is thus configured as a cutting strand tool guiding device. In this case, the cutting edge guiding device 28a comprises at least one guide element 30a for guidance of the machining tool 10a during a movement along a cutting edge. To this end, the guide element 30a comprises at least one guide groove 32a, into which the machining tool 10a during machining of a workpiece 34a extends at least partially (FIG. 3). The guide element 30a, in particular the guide groove 32a, in this case comprises at least one maximum guide geometry extent 68a, which, viewed along a direction running at least substantially parallel to a cutting plane of the cutting strand 12a, is equal to or greater than a maximum longitudinal extent 70a of the cutting edge guide element 20a of the cutting edge guide unit 16a (FIG. 3). The further cutting edge guide element 20a has a maximum longitudinal extent which, in terms of a linear dimension, is equal to a maximum longitudinal extent of the further cutting edge guide element 48a. The cutting edge guide element 20a and the further cutting edge guide element 48a, during guidance by means of the cutting edge guiding device 28a, is thus disposed within the guide groove 32a.

The guide element 30a is configured as a guide rail. In this case, the guide element 30a has at least one workpiece support surface 54a, on which the workpiece 34a is arrangeable for machining by means of the machining tool 10a. The guide element 30a can be removably arranged on a work plate 56a of a machining table 58a of the cutting edge guiding device 28a. In this case, the guide element 30a is removably recessed in the work plate 56a, wherein a surface of the work plate 56a is arranged at least substantially flush with the workpiece support surface 54a. It is also conceivable, however, for the surface of the work plate 56a to be arranged relatively distant from the workpiece support surface 54a.

The guide element 30a comprises, furthermore, at least one constraining force transmission surface, which is designed to exert on the machining tool 10a, for guidance of the machining tool 10a, at least one constraining force along at least one direction running substantially transversely to the motional direction of the machining. To this end, the cutting edge guide unit 16a, in particular the cutting edge guide element 20a and/or the further cutting edge guide element 48a, during a movement along the motional direction of the machining, bears against the constraining force transmission surface. In addition, the guide element 30a has at least one further constraining force transmission surface, which is designed to exert on the machining tool 10a, for guidance of this same, at least one constraining force along at least one further direction running at least substantially transversely to the motional direction of the machining. The constraining force transmission surface and the further constraining force transmission surface extend in this case at least substantially in parallel. The constraining force transmission surface and the further constraining force transmission surface delimit the guide groove 32a. In this case, the guide groove 32a has at least in one section a design corresponding to an external geometry of the machining tool 10a, in particular to the external geometry of the cutting edge guide unit 16a. Further embodiments of the cutting edge guide unit 16a and/or of the cutting edge guiding device 28a, which embodiments appear sensible to a person skilled in the art, are likewise conceivable.

FIG. 4 shows a sectional view of an alternative embodiment of a guide element 30a′ of the portable power tool system 24a according to the invention. The guide element 30a′ is configured as a guide rail, which has a guide geometry that varies along at least one direction. In this case, the guide element 30a′ has a guide groove 32a′, which, viewed along a direction running at least substantially perpendicular to a workpiece support surface 54a′ of the guide element 30a′, has an incrementally varying distance between a forced guidance surface and a further forced guidance surface of the guide element 30a′. The forced guidance surface and the further forced guidance surface delimit the guide groove 32a′. Thus the guide element 30a′ has an incrementally varying guide groove geometry. In this case, it is also conceivable for the guide element 30a′, in particular the guide groove 32a′, to have another guide geometry that appears sensible to a person skilled in the art and varies along at least one direction, such as, for instance, a lead-in taper, a guiding step, etc.

Furthermore, the guide element 30a′ alternatively or additionally comprises at least one wear element 64a′, which is disposed in the region of the varying guide geometry or on the forced guidance surface and/or on the further forced guidance surface. Thus the guide element 30a′ alternatively or additionally comprises at least two wear elements 64a′, 66a′. The wear elements 64a′, 66a′ are disposed on two mutually facing sides of the guide groove. It is also conceivable, however, for the guide element 30a′ alternatively or additionally to have a number of wear elements 64a′, 66a′ other than two.

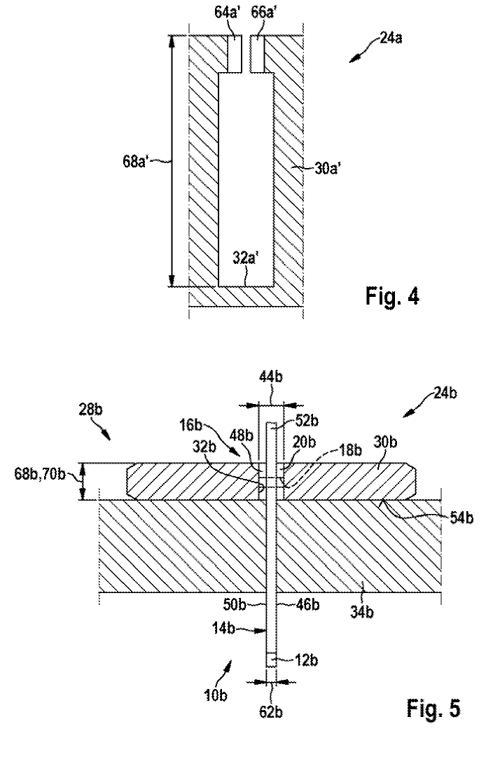

In FIGS. 5 to 9, alternative illustrative embodiments are represented. Substantially constant components, features and functions are basically numbered with the same reference symbols. In order to differentiate between the illustrative embodiments, letters a to d are added to the reference symbols of the illustrative embodiments. The following description substantially confines itself to the differences from the first illustrative embodiment described in FIGS. 1 to 4, wherein, in respect of constant components, features and functions, reference can be made to the description of the first illustrative embodiment in FIGS. 1 to 4.

FIG. 5 shows an alternative portable power tool system 24b, which comprises a portable power tool (not represented in detail here), at least one machining tool 10b and at least one cutting edge guiding device 28b, which latter has at least one guide element 30b designed to interact with a cutting edge guide unit 16b of the machining tool 10b. The portable power tool of the alternative portable power tool system 24b has an at least substantially analogous design in comparison to the portable power tool 26a represented in FIG. 1. The machining tool 10b comprises at least one cutting strand 12b and at least one cutting strand guide unit 14b. In addition, the machining tool 10b comprises at least the cutting edge guide unit 16b arrangeable on the cutting strand guide unit 14b and having a maximum transverse extent 44b which is equal to or greater than a maximum cutting width 62b of the cutting strand 12b.

Unlike the cutting edge guiding device 28a described in the description of FIGS. 1 to 4, the cutting edge guiding device 28b of the alternative portable power tool system 24b has at least one guide element 30b, comprising a workpiece support surface 54b by means of which the guide element 30b can be placed on a workpiece 34b. The guide element 30b is configured as a guide rail, comprising a guide groove 32b into which the machining tool 10b during machining of the workpiece 34b extends at least partially. In this case, the machining tool 10b extends, for machining of the workpiece 34b, at least partially through the guide element 30b. The machining tool 10b of the alternative portable power tool system 24b has an at least substantially analogous design to the machining tool 10a described in the description of FIGS. 1 to 4. Thus, in terms of further functions and features of the machining tool 10b and an interaction of the machining tool 10b and the cutting edge guiding device 28b, reference may be made to the description of FIGS. 1 to 4.

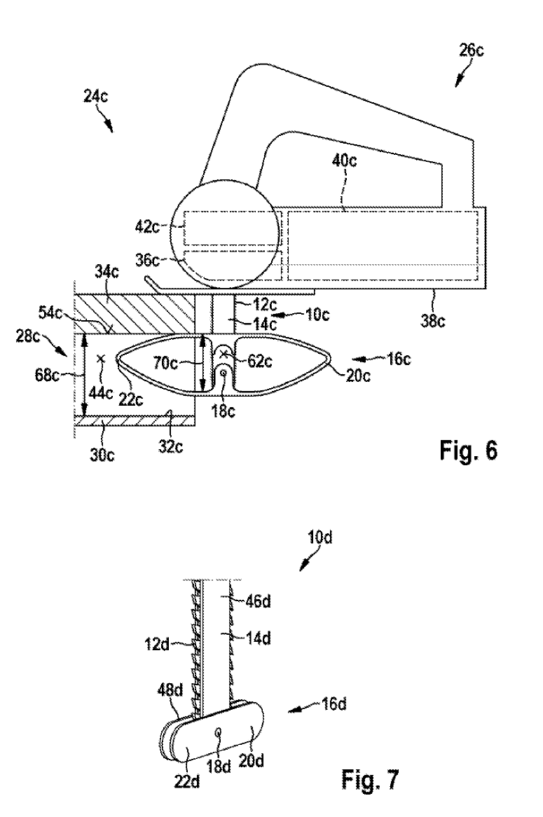

FIG. 6 shows a further alternative portable power tool system 24c, which comprises a portable power tool 26c, at least one machining tool 10c and at least one cutting edge guiding device 28c, which latter has at least one guide element 30c designed to interact with a cutting edge guide unit 16c of the machining tool 10c. The portable power tool 26c of the further alternative portable power tool system 24c has an at least substantially analogous design in comparison to the portable power tool 26a represented in FIG. 1. The machining tool 10c comprises at least one cutting strand 12c and at least one cutting strand guide unit 14c. In addition, the machining tool 10c comprises at least the cutting edge guide unit 16c arrangeable on the cutting strand guide unit 14c and having a maximum transverse extent 44c which is equal to or greater than a maximum cutting width 62c of the cutting strand 12c.

Unlike the machining tool 10a described in the description of FIGS. 1 to 4, the machining tool 10c of the alternative portable power tool system 24c comprises the cutting edge guide unit 16c, which has at least one cutting edge guide element 20c, movably mounted on the cutting strand guide unit 14c of the machining tool 10c. In this case, the cutting edge guide element 20c is mounted on the cutting strand guide unit 14c such that it is at least partially translatorily movable along a longitudinal axis of the cutting strand guide unit 14c. In a state disposed on the cutting strand guide unit 14c, the cutting edge guide element 20c has an oval design. In this case, the cutting edge guide element 20c is fastened with an arm to the cutting strand guide unit 14c by means of a fastening element 18c of the cutting edge guide unit 16c. A further arm of the cutting edge guide element 20c is disposed in a translatorily movable manner on the cutting strand guide unit 14c. The arm and the further arm are in this case configured in one piece with each other. As a result of a translatory movement of the further arm relative to the arm fastened to the cutting strand guide unit 14c, a deformation of the cutting edge guide element 20c takes place. In this case, the cutting edge guide element 20c is of resilient configuration. Thus, by means of the cutting edge guide element 20c, a spring force can be generated, which spring force pressurizes the workpiece 34c, starting from the cutting edge guide element 20c, in the direction of a support unit 60c of the portable power tool 26c. The cutting edge guide unit 16c further comprises a further cutting edge guide element (not represented here), which has an at least substantially analogous design to the cutting edge guide element 20c. In addition, the further cutting edge guide element is disposed on a side of the cutting strand guide unit 14c which is facing away from the cutting edge guide element 20c.

Furthermore, the cutting edge guide unit 16c has at least one stop element 22c, which, viewed along a direction running at least substantially parallel to a cutting plane of a cutting strand 12c of the machining tool 10c, extends beyond the cutting strand 12c. The stop element 22c is in this case configured at least partially in one piece with the cutting edge guide element 20c of the cutting edge guide unit 16c. The stop element 22c is thus of resilient configuration. In terms of further functions and features of the machining tool 10c and an interaction of the machining tool 10c and the cutting edge guiding device 28c, reference may be made to the description of FIGS. 1 to 4.

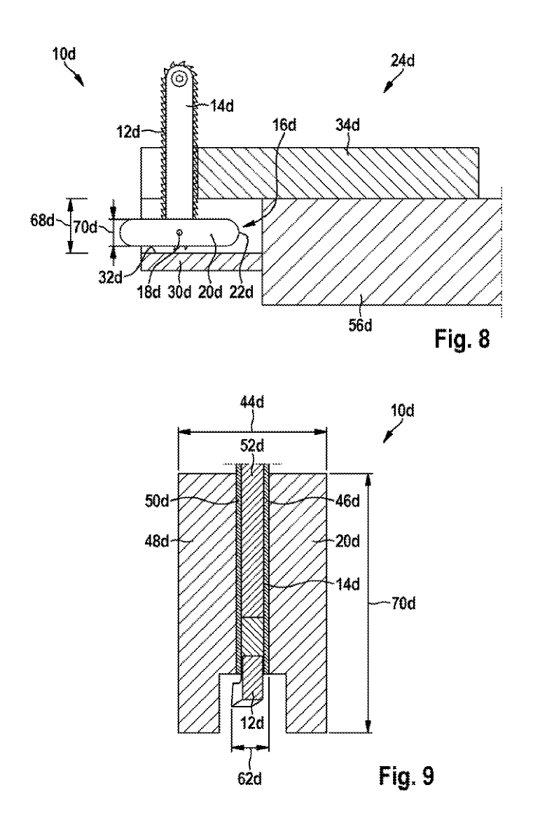

FIGS. 7 to 9 show a further alternative portable power tool system 24d, which comprises a portable power tool (not represented in detail here), at least one machining tool 10d and at least one cutting edge guiding device 28d, which latter has at least one guide element 30d designed to interact with a cutting edge guide unit 16d of the machining tool 10d (FIG. 8).

The portable power tool of the further alternative portable power tool system 24d has an at least substantially analogous design in comparison to the portable power tool 26a represented in FIG. 1. The machining tool 10d comprises at least one cutting strand 12d and at least one cutting strand guide unit 14d. In addition, the machining tool 10d comprises at least the cutting edge guide unit 16d arrangeable on the cutting strand guide unit 14d and having a maximum transverse extent 44d which is equal to or greater than a maximum cutting width 62d of the cutting strand 12d (FIG. 9).

Furthermore, the cutting edge guide unit 16d has at least one stop element 22d, which, viewed along at least one direction running at least substantially parallel to a cutting plane of the cutting strand 12d, extends beyond the cutting strand 12d. In this case, the stop element 22d extends along at least two directions running at least substantially perpendicular to each other, which directions run at least substantially parallel to a cutting plane of the cutting strand 12d, beyond the cutting strand 12d (FIGS. 8 and 9). The stop element 22d is configured at least partially in one piece with a cutting edge guide element 20d of the cutting edge guide unit 16d. The cutting edge guide element 20d can in this case be movably mounted on the cutting strand guide unit 14d. In terms of further functions and features of the machining tool 10d and an interaction of the machining tool 10d and the cutting edge guiding device 28d, reference may be made to the description of FIGS. 1 to 4.

1. A machining tool, comprising:
at least one cutting strand.
at least one cutting strand guide unit; and
at least one cutting edge guide unit arrangeable on the cutting strand guide unit, the cutting edge guide unit having a maximum transverse extent that is equal to or greater than a maximum cutting width of the cutting strand.

2. The machining tool as claimed in claim 1, wherein the cutting edge guide unit has at least one fastening element configured for one or more of a positive and/or a non-positive fastening to the cutting strand guide unit.

3. The machining tool as claimed in claim 1, wherein the cutting edge guide unit has at least one cutting edge guide element that is movably mounted on the cutting strand guide unit.

4. The machining tool as claimed in claim 1, wherein the cutting edge guide unit (16c; 16d) has at least one stop element that, when viewed along at least one direction running at least substantially parallel to a cutting plane of the cutting strand, extends beyond the cutting strand.

5. The machining tool as claimed in claim 4, wherein the stop element is configured at least partially in one piece with a cutting edge guide element of the cutting edge guide unit.

6. The machining tool as claimed in claim 4, wherein the stop element is of resilient configuration.

7. A portable power tool system, comprising:
at least one portable power tool.
at least one machining tool including:
at least one cutting strand,
at least one cutting strand guide unit, and
at least one cutting edge guide unit arrangeable on the cutting strand guide unit, the cutting edge guide unit having a maximum transverse extent that is equal to or greater than a maximum cutting width of the cutting strand; and
at least one cutting edge guiding device including at least one guide element configured to interact with the cutting edge guide unit of the machining tool.

8. The portable power tool system as claimed in claim 7, wherein the guide element is configured as a guide rail having a guide geometry that varies along at least one direction.

9. The portable power tool system as claimed in claim 7, wherein the guide element comprises at least one maximum guide geometry extent that, when viewed along a direction running at least substantially parallel to a cutting plane of the cutting strand, is equal to or greater than a maximum longitudinal extent of a cutting edge guide element of the cutting edge guide unit.

10. The portable power tool system as claimed in claim 7, wherein the guide element comprises at least one guide groove into which the machining tool extends at least partially during machining of a workpiece.

11. The machining tool as claimed in claim 1, wherein the machining tool is configured as a rotating cutter machining tool.
